(19) United States
(12) Patent Application Publication
(10) Pub. No.: US 2008/0246754 A1
(43) Pub. Date: Oct. 9, 2008

(54) Method of driving discharge display panel performing adaptive initialization

(76) Inventor: Hak-Ki Choi, Suwon-si (KR)

Correspondence Address: ROBERT E. BUSHNELL, 1522 K STREET NW, SUITE 300, WASHINGTON, DC, 20005-1202, US

(21) Appl. No.: 12/007,976

(22) Filed: Jan. 17, 2008

(30) Foreign Application Priority Data
Apr. 9, 2007 (KR) 10-2007-0034614

(51) Int. Cl. G09G 5/00

(52) U.S. Cl. 345/214; 345/60

(57) ABSTRACT

Provided is a method of driving a discharge display panel that applies a reset driving signal to all display cell in the discharge display panel during an initialization period. The reset driving signal includes a rising voltage signal and a descending voltage signal. A rising rate of the rising voltage signal and the descending rate of the descending voltage signal change depending on temperature of the discharge display panel.

### CLAIM OF PRIORITY

This application makes reference to, incorporates the same herein, and claims all benefits accruing under 35 U.S.C. § 119 from an application for METHOD OF DRIVING DISCHARGE DISPLAY PANEL PERFORMING ADAPTIVE INITIALIZATION earlier filed in the Korean Intellectual Property Office on the Apr. 9, 2007 and there duly assigned Serial No. 10-2007-0034614.

### BACKGROUND OF THE INVENTION

1. Field of the Invention

The present invention relates to a method of driving a discharge display panel, and more particularly, to a method of driving a discharge display panel by applying a reset driving signal to all display cell in the discharge display panel during a initialization period. The reset driving signal includes a rising voltage signal and a descending voltage signal. A rising rate of the rising voltage signal and the descending rate of the descending voltage signal change depending on temperature of the discharge display panel.

2. Description of the Related Art

In the discharge display panels, for example, a plasma display apparatus disclosed in U.S. Pat. No. 5,541,618, a unit frame includes a plurality of sub-fields for time-divisional gradation, and each of the sub-fields includes a reset period, an addressing period, and a sustain period. Each of the sub-fields has a gradation weighed value, and the sustain periods are selected based on the gradation weighed value.

In the contemporary method of driving the discharge display panel, rising voltages and descending voltages are repeatedly applied to all display cells of the discharge display panel in order to initialize the display cells in the discharge display panel during an initialization time (reset period). However, the same rising and descending voltages are always applied to the discharge display panel, while some operation conditions of the discharge display panel, such as temperature of the discharge display panel, is varying. Therefore, in some case, the rising and descending voltages are not optimized at the conditions of the discharge display panel. In this case, the display cells cannot be completely initialized during the initialization time, and thus, the discharge display panel could abnormally display images.

### SUMMARY OF THE INVENTION

The present invention provides a method of driving a discharge display panel that is always optimized at the various operation conditions of the discharge display panel. Therefore, the method of the present invention provides stable operations of the discharge display panel, and prevents malfunctions of the discharge display panel.

According to an aspect of the present invention, there is provided a method of driving a discharge display panel. The method includes steps of detecting temperature around the discharge display panel, and applying a reset driving signal to all display cells in the discharge display panel. The reset driving signal sets the all display cells on an identical condition for discharge. The reset driving signal includes a rising voltage signal and a descending voltage signal. The step of applying the reset driving signal includes steps of adjusting a rising rate of the rising voltage signal and a descending rate of the descending voltage signal in dependence on the temperature, applying the rising voltage signal during a rising application period, and applying the descending voltage signal during a descending application period.

The method may further includes a step of repeatedly applying the set of the rising voltage signal and the descending voltage signal to the discharge display panel.

The step of applying the rising voltage signal may include steps of applying the rising voltage signal at a first rising rate if the temperature is in a first temperature range, and applying the rising voltage signal at a second rising rate if the temperature is below the first temperature range. The second rising rate may be smaller than the first rising rate. The step of applying the descending voltage signal may include steps of applying the descending voltage signal at a first descending rate if the temperature is in the first temperature range, and applying the descending voltage signal at a second descending rate if the temperature is below the first temperature range. The second descending rate may be smaller than the first descending rising rate. The step of applying the rising voltage signal may further include a step of applying the rising voltage signal at a third rising rate if the temperature is above the first temperature range. The third rising rate may be greater than the first rising rate. The step of applying the descending voltage signal may include a step of applying the descending voltage signal at a third descending rate if the temperature is above the first temperature range. The third descending rate may be greater than the first descending rising rate.

A peak voltage of the rising voltage signal may be set as a constant regardless of the temperature. The step of applying the rising voltage signal may further include steps of applying the rising voltage signal during a first rising application period if the temperature is in a first temperature range, applying the rising voltage signal during a second rising application period if the temperature is below the first temperature range, and applying the rising voltage signal during a third rising application period if the temperature is above the first temperature range. The second rising application period may be longer than the first rising application period, and the third rising application period may be shorter than the first rising application period.

The step of applying the descending voltage signal may further include steps of applying the descending voltage signal during a first descending application period if the temperature is in a first temperature range, applying the descending voltage signal during a second descending application period if the temperature is below the first temperature range, and applying the rising voltage signal at a third descending application period if the temperature is above the first temperature range. The second descending application period maybe longer than the first descending application period, and the third descending application period may be shorter than the first descending application period.

Each of the rising application period and the descending application period may be set as a constant regardless of the temperature. The rising voltage signal may have a first peak voltage if the temperature is in a first temperature range, the rising voltage signal may have a second peak voltage if the temperature is below the first temperature range, and the rising voltage signal may have a third peak voltage if the temperature is above the first temperature range. The second peak voltage may be smaller than the first peak voltage, and the third peak voltage may be greater than the first peak voltage.

The step of applying the rising voltage signal may further include steps of applying the rising voltage signal having a first peak voltage during a first rising application period if the temperature is in a first temperature range, applying the rising voltage signal having a second peak voltage during a second rising application period if the temperature is below the first temperature range, and applying the rising voltage signal having a third peak voltage during a third rising application period if the temperature is above the first temperature range. The second rising application period may be longer than the first rising application period, the second peak voltage may be smaller than the first peak voltage, the third rising application period may be shorter than the first rising application period, and the third peak voltage may be greater than the first peak voltage.

According to the method of driving the discharge display panel, when the temperature around the discharge display panel is lowered, the rates of changing the rising voltage and/or the descending voltage may be lowered. Accordingly, the problem wherein weak and slow discharge does not occur while strong and rapid discharge occurs well in the low temperature range, may be solved.

On the other hand, when the temperature around the discharge display panel is increased, the rates of changing the rising voltage and/or the descending voltage may be increased. Accordingly, the problem wherein strong and rapid discharge does not occur while weak and slow discharge occurs well in the high temperature range, may be solved.

That is, the strong and rapid discharge occurs sufficiently while the weak and slow discharge also occurs sufficiently without being dependant on the temperature around the discharge display panel. That is, the discharge can occur in synchronization in all of the discharge cells having different discharging conditions from each other. Therefore, the display cells can be initialized stably in the initialization time from the point when the electric power is applied, and thus, the display can be performed sufficiently at the initial stage of driving the panel.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of a plasma display panel as an example of a discharge display panel that can be driven by a driving method proposed as an embodiment of the present invention;

FIG. 2 is a cross-sectional view of a unit display cell of the discharge display panel of FIG. 1;

FIG. 3 shows a unit frame of an address-display separation driving method for the plasma display panel of FIG. 1;

FIG. 4 is a block diagram showing a driving apparatus performing the driving method of the embodiment of the present invention;

FIG. 5 shows driving signals in a unit sub-field as a function of time, which is applied to the plasma display panel of FIG. 1;

FIG. 6 is a cross-sectional view showing a distribution of wall charges in a display cell at a time point of t52 shown in FIG. 5;

FIG. 7 is a cross-sectional view showing a distribution of wall charges in a display cell at a time point of t54 shown in FIG. 5;

FIG. 8 is a diagram showing a scan driving circuit and a switching output circuit in a Y-driving unit of the driving apparatus shown in FIG. 4;

FIG. 9 is a diagram of a reset/sustain circuit shown in FIG. 8;

FIG. 10 is a diagram of an inner circuit in an X-driving unit of the driving apparatus shown in FIG. 4;

FIG. 11 is a circuit diagram of a driving buffer for grounding source potentials of field-effect transistors of FIGS. 8 through 10;

FIG. 12 shows a first example of driving signals applied to X electrode lines and Y electrode lines in which temperature of the plasma display panel of FIG. 1 during an initialization time is in a normal temperature range;

FIG. 13 shows a first example of driving signals applied to X electrode lines and Y electrode lines in which peripheral temperature of the plasma display panel of FIG. 1 during an initialization time is in a lower temperature range;

FIG. 14 shows a first example of driving signals applied to X electrode lines and Y electrode lines in which peripheral temperature of the plasma display panel of FIG. 1 during an initialization time is in a higher temperature range;

FIG. 15 shows a second example of driving signals applied to X electrode lines and Y electrode lines in which peripheral temperature of the plasma display panel of FIG. 1 during an initialization time is in a lower temperature range;

FIG. 16 shows a second example of driving signals applied to X electrode lines and Y electrode lines in which peripheral temperature of the plasma display panel of FIG. 1 during an initialization time is in a higher temperature range;

FIG. 17 shows a third example of driving signals applied to X electrode lines and Y electrode lines in which peripheral temperature of the plasma display panel of FIG. 1 during an initialization time is in a lower temperature range; and

FIG. 18 shows a third example of driving signals applied to X electrode lines and Y electrode lines in which peripheral temperature of the plasma display panel of FIG. 1 during an initialization time is in a higher temperature range.

### DETAILED DESCRIPTION OF THE INVENTION

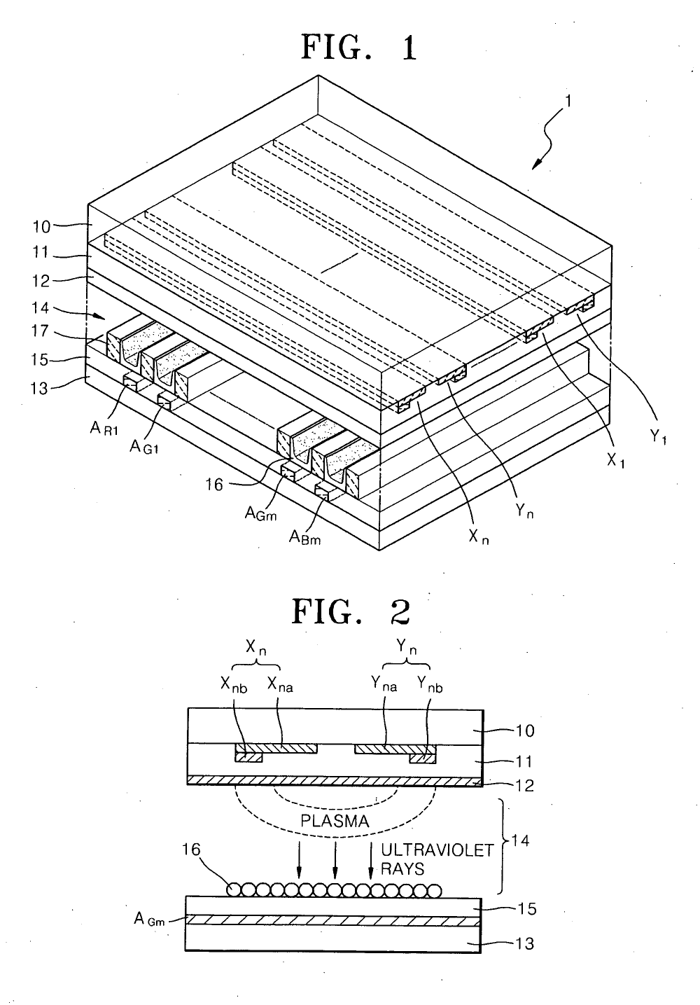

FIG. 1 shows a structure of a plasma display panel 1 as an example of a discharge display panel that is driven by a driving method proposed as an embodiment of the present invention. FIG. 2 shows a structure of a unit display cell of the plasma display panel 1. Referring to FIGS. 1 and 2, address electrode lines A_{R1}, . . . , A_{Bm}, dielectric layers 11 and 15, Y electrode lines as scan electrode lines Y₁, . . . , Yₙ, X electrode lines X₁, . . . , Xₙ, phosphor materials 16, barrier ribs 17, and a protection layer (an MgO layer) 12 are formed between front and rear glass substrates 10 and 13 of the surface-discharge plasma display panel 1.

The address electrode lines A_{R1}, . . . , A_{Bm} are formed on a front surface of the rear glass substrate 13 in a predetermined pattern. The lower dielectric layer 15 is applied to entirely cover the address electrode lines A_{R1}, . . . , A_{Bm}. The barrier ribs 17 are formed in parallel with the address electrode lines A_{R1}, . . . , A_{Bm} on the lower dielectric layer 15. The barrier ribs 17 define discharge regions of cells, and prevent cross talks between cells. The phosphor layer 16 is applied between the barrier ribs 17.

The X electrode lines X₁, . . . , Xₙ and the Y electrode lines Y₁, . . . , Yₙ are formed on a rear surface of the front glass substrate 10 in a predetermined pattern so as to cross the address electrode lines A_{R1}, . . . , A_{Bm}. Each of crossing points of the address electrode lines and the X and Y electrode lines defines a corresponding cell. Each of the X electrode lines X₁, . . . , Xₙ and each of the Y electrode lines Y₁, . . . , Yₙ are formed by combining transparent electrode lines (Xₙₐ, Yₙₐ of FIG. 2) that are transparent conductive material such as an indium tin oxide (ITO), and metal electrode lines (X_{nb}, Y_{nb} of FIG. 2) for improving a conductivity. The front dielectric layer 11 is applied onto the entire X electrode lines X₁, . . . , Xₙ and the Y electrode lines Y₁, . . . , Yₙ. The protection layer 12, for example, an MgO layer, for protecting the plasma display panel against a strong electric field is entirely applied on the front dielectric layer 11. A plasma gas is sealed in the discharge space 14.

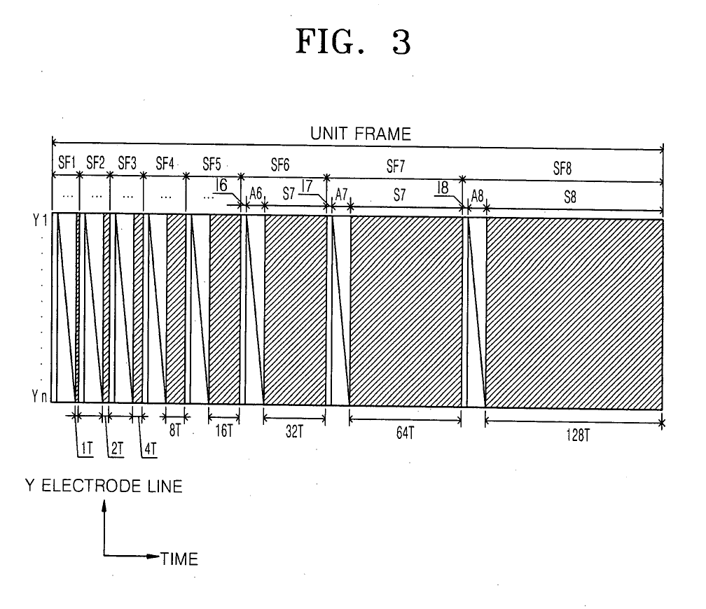

FIG. 3 illustrates a unit frame of an address-display separation driving method for the plasma display panel 1 of FIG. 1. Referring to FIG. 3, each unit frame to be applied to the discharge display panel is divided into 8 sub-fields SF1, . . . , SF8 for time-divisional gradation. In addition, each of the sub-fields SF1, . . . , SF8 is divided into a reset period (I1, . . . , I8), an address period (A1, . . . , A8), and a sustain period (S1, . . . , S8).

During the reset periods (I1, . . . , I8), reset driving signals are applied to all of the discharge cells of the discharge display panel, and discharge conditions of all of the display cells are made identical.

In each of the address periods (A1, . . . , A8), whenever a display data signal is applied to the address electrode lines (A_{R1}, . . . , A_{Bm} of FIG. 1), scan pulses are sequentially applied to the corresponding Y electrode lines (Y₁, . . . , Yₙ). Accordingly, when the display data signal of high level is applied while the scan pulses are being applied, a wall voltage that is higher than a set level is formed due to the address discharge in the corresponding discharge cell (i.e. in the cells that are addressed), and the wall voltages higher than the set level are not formed in the other discharge cells (i.e. the cells that are not addressed).

In each of the sustain periods (S1, . . . , S8), sustain pulses are alternatively applied to all of the Y electrode lines (Y₁, . . . , Yₙ) and all of the X electrode lines (X₁, . . . , Xₙ), and thus, display discharges occur in the discharge cells in which the wall voltages higher than the set level are formed in the corresponding address periods (A1, . . . , A8). Therefore, a brightness of each discharge cell is in proportion to a total length of the sustain periods (S1, . . . , S8) in the unit frame which have been selected during the addressing. The total length of the sustain periods (S1, . . . , S8) in the unit frame is 255T (T denotes a unit time). Therefore, 256 gradations including non-display of the corresponding unit frame can be represented.

In the unit frame, a time corresponding to 2⁰ (1T, where T is a predetermined length of time) is assigned to the sustain period S1 of the first sub-field (SF1), a time corresponding to 2¹ (2T) is assigned to the sustain period S2 of the second sub-field (SF2), a time corresponding to 2² (4T) is assigned to the sustain period S3 of the third sub-field (SF3), a time corresponding to 2³ (8T) is assigned to the sustain period S4 of the fourth sub-field (SF4), a time corresponding to 2⁴ (16T) is assigned to the sustain period S5 of the fifth sub-field (SF5), a time corresponding to 2⁵ (32T) is assigned to the sustain period S6 of the sixth sub-field (SF6), a time corresponding to 2⁶ (64T) is assigned to the sustain period S7 of the seventh sub-field (SF7), and a time corresponding to 2⁷ (128T) is assigned to the sustain period S8 of the eighth sub-field (SF8). Accordingly, 256 gradations including zero gradation, that is, non-display gradation, can be represented by selecting the sub-fields to be displayed among the 8 sub-fields.

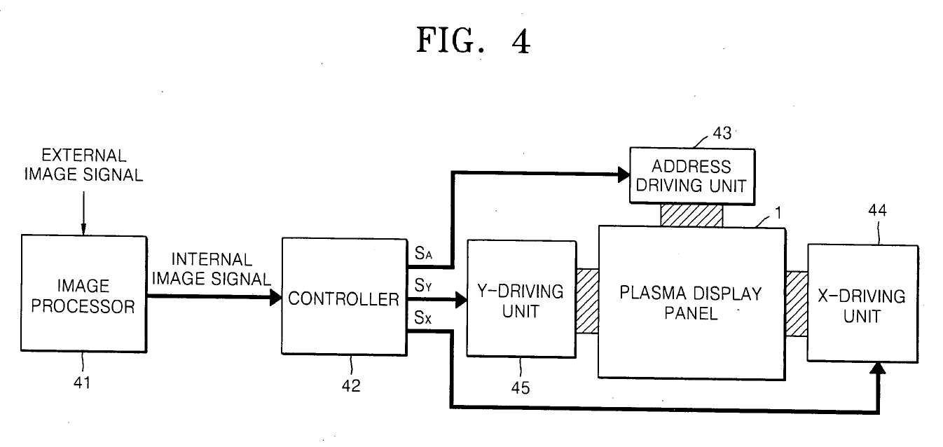

Referring to FIG. 4, a driving apparatus of the discharge display panel of the embodiment of the present invention includes an image processor 41, a controller 42, an address driving unit 43, an X driving unit 44, and a Y driving unit 45.

The image processor 41 converts an external analog signal into a digital signal to generate internal image signals, for example, red (R), green (G), and blue (B) image data of 8 bits, a clock signal, and vertical and horizontal synchronization signals. The controller 42 generates driving control signals (S_{A}, S_{Y}, S_{X}) according to the internal image signals from the image processor 41.

The address driving unit 43 processes an address signal (S_{A}) among the driving control signals (S_{A}, S_{Y}, S_{X}) of the controller 42 to generate the display data signal, and applies the display data signal to the address electrode lines (A_{R1}, . . . , A_{Bm} of FIG. 1) of the plasma display panel 1. The X-driving unit 44 processes an X-driving control signal (S_{X}) among the driving control signals (S_{A}, S_{Y}, S_{X}) of the controller 42 to drive the X electrode lines (X₁, . . . , Xₙ of FIG. 1) of the plasma display panel 1. The Y-driving unit 45 processes a Y-driving control signal (S_{Y}) among the driving control signals (S_{A}, S_{Y}, S_{X}) of the controller 42 to drive the Y-electrode lines (Y₁, . . . , Yₙ of FIG. 1) of the plasma display panel 1. A temperature sensor (not shown) can be installed on the plasma display panel 1 to measure temperature of the plasma display panel 1. Data of the measured temperature is transferred to the controller 42. The controller 42, then, adjust parameters of the reset driving signal, such as pulse widths and pulse heights of driving signals, according to the measured temperature data. The controller 42 also includes an internal clock (not shown) that generates system clock pulses. Therefore, the controller 42 can change pulse widths of driving signals by controlling the clock pulses.

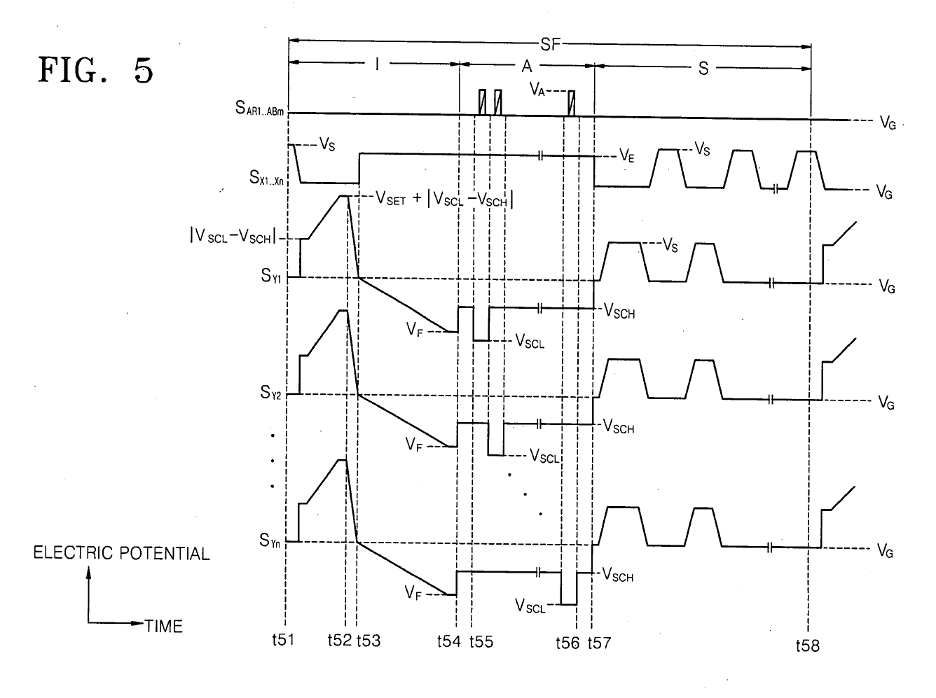

FIG. 5 shows driving signals, in a unit sub-field (SF), applied to the plasma display panel 1 of FIG. 1. The driving signals are provided from the driving apparatus of FIG. 4. In FIG. 5, reference numerals S_{AR1 . . . ABm} denote the driving signals applied to the address electrode lines (A_{R1}, A_{G1}, . . . , A_{Gm}, A_{Bm} of FIG. 1), reference numerals S_{X1 . . . Xn} are the driving signals applied to the X electrode lines (X₁, . . . Xₙ of FIG. 1), and reference numerals S_{Y1}, . . . , S_{Yn}, denote the driving signals applied to the Y electrode lines (Y₁, . . . , Yₙ of FIG. 1).

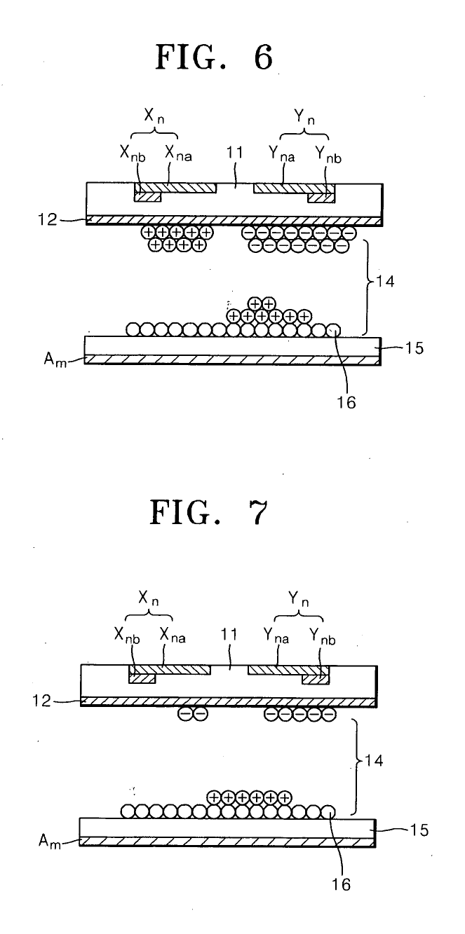

FIG. 6 shows a distribution of wall charges in a display cell at a time point of t52 of FIG. 5. FIG. 7 shows a distribution of wall charges in a display cell at a time point of t54 of FIG. In FIGS. 6 and 7, the same reference numerals as those of FIG. 2 denote the same elements. A method of driving the plasma display panel 1 will be described as follows referring to FIGS. 1, 5 through 7.

In a potential rising period (t51˜t52) of the reset period (I) of the unit sub-field (SF), an electric potential applied to the Y electrode lines (Y₁, . . . , Yₙ) rises continuously from a fifth potential (|V_{SCL}−V_{SCH}|, for example, 120 V) to a first potential (V_{SET}+|V_{SCL}−V_{SCH}|, for example, 315 V), which is higher than the fifth potential (|V_{SCL}−V_{SCH}|) by a sixth potential (V_{SET}, for example, 195 V). Here, the fifth potential (|V_{SCL}−V_{SCH}|) is a positive potential that has the magnitude corresponding to a difference between a third potential (V_{SCH}, as a scan-bias potential, for example, −70V) and a fourth potential (V_{SCL}, as a scan potential, for example, −190V). A ground potential (V_{G}) is applied to the X electrode lines (X₁, . . . , Xₙ) and to the address electrode lines (A_{R1}, . . . , A_{Bm}).

Accordingly, discharges occur between the Y electrode lines (Y₁, . . . , Yₙ) and the X electrode lines (X₁, . . . , Xₙ), and discharges also occur between the Y electrode lines (Y₁, . . . , Yₙ) and the address electrode lines (A_{R1}, . . . , A_{Bm}). Accordingly, negative wall charges are formed around the Y electrode lines (Y₁, . . . , Yₙ), positive wall charges are formed around the X electrode lines (X₁, . . . , Xₙ), and positive wall charges are formed around the address electrode lines (A_{R1}, . . . , A_{Bm}) (refer to FIG. 6).

In a first potential descending period (t52˜t53) of the reset period (I), the electric potential applied to the Y electrode lines (Y₁, . . . , Yₙ) rapidly descends from the first potential (V_{SET}+|V_{SCL}−V_{SCH}|) to the ground potential (V_{G}), while the ground potential (V_{G}) is being applied to the X electrode lines (X₁, . . . , Xₙ) and to the address electrode lines (A_{R1}, . . . , A_{Bm}).

In a second potential descending period (t53˜t54) in the reset period (I), the electric potential applied to the Y electrode lines (Y₁, . . . , Yₙ) slowly descends from the ground potential (V_{G}) to a second potential (V_{F}) that is a negative potential, for example, −170V. In this second potential descending period, a ninth potential (V_{E} for example, 110 V) is applied to the X electrode lines (X₁, . . . , Xₙ), while the ground potential (V_{G}) is being applied to the address electrode lines (A_{R1} . . . , A_{bm}).

In the above first and second potential descending periods (t52˜t54), some of the negative wall charges around the Y electrode lines (Y₁, . . . , Yₙ) move toward the X electrode lines (X₁, . . . , Xₙ) due to the discharge between the X electrode lines (X₁, . . . , Xₙ) and the Y electrode lines (Y₁, . . . , Yₙ). In addition, since the ground potential (V_{G}) is applied to the address electrode lines (A_{R1}, . . . , A_{Bm}), more positive wall charges are formed around the address electrode lines (A_{R1}, . . . A_{Bm}) (refer to FIG. 7).

Accordingly, in the subsequent addressing period (A), when the display data signal is applied to the address electrode lines (A_{R1}, . . . , A_{Bm}) and the scan pulses of the fourth potential (V_{SCL}) are sequentially applied to the Y electrode lines (Y₁, . . . , Yₙ) that are biased to the third potential (V_{SCH}), the addressing can be performed sufficiently. Here, the third potential (V_{SCH}) that is the scan-bias potential is a negative potential that is lower than the ground potential (V_{G}), and is higher than the second potential (V_{F}) that is the reset-descending potential. However, the fourth potential (V_{SCL}) that is the scan potential is lower than the second potential (V_{F}).

The address potential (V_{A}), for example, 65 V, is applied to the display data signal that is applied to each of the address electrode lines (A_{R1}, . . . , A_{Bm}) in a case that the display cell is to be selected. Otherwise, a ground voltage (V_{G}) is applied to the display data signal. Accordingly, if the display data signal of the address potential (V_{A}) is applied when the scan pulse of the fourth potential (V_{SCL}) is being applied, the wall potential that is higher than a predetermined level is formed in the corresponding display cell due to the address discharge, and the wall potential that is higher than the predetermined level is not formed in the other display cells to which the address potential (V_{A}) is not applied. Here, the ninth potential (V_{E}) is applied to the X electrode lines (X₁, . . . Xₙ) for performing the discharge precisely and efficiently.

In the sustain period (S), sustain pulses of a seventh potential (V_{S}) are alternatively applied to the Y electrode lines (Y₁, . . . , Yₙ) and the X electrode lines (X₁, . . . Xₙ), and thus, sustain discharge occurs in the display cell where the wall charges are formed in the corresponding addressing period (A).

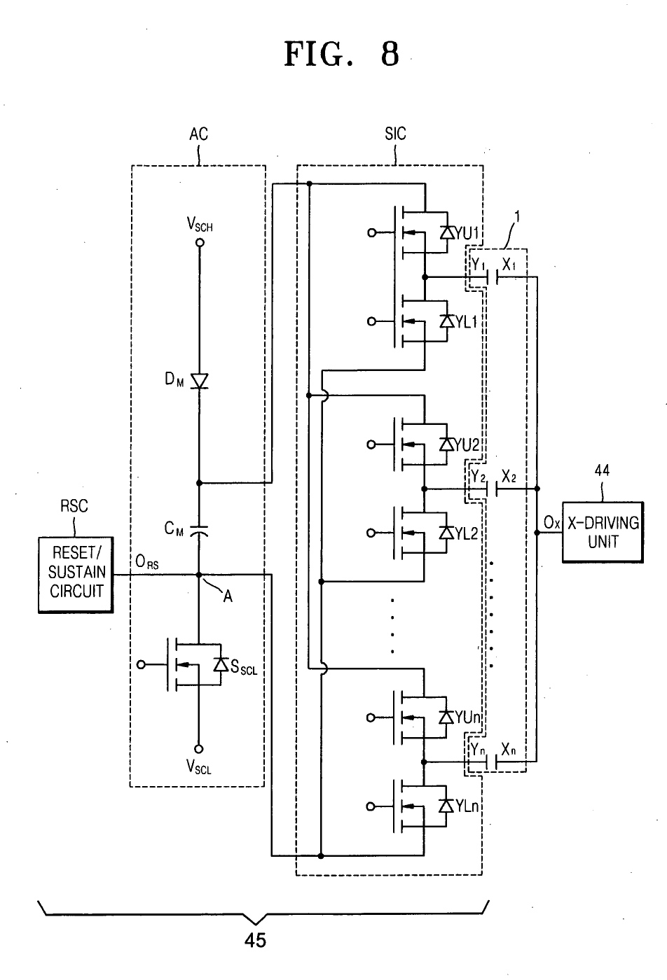

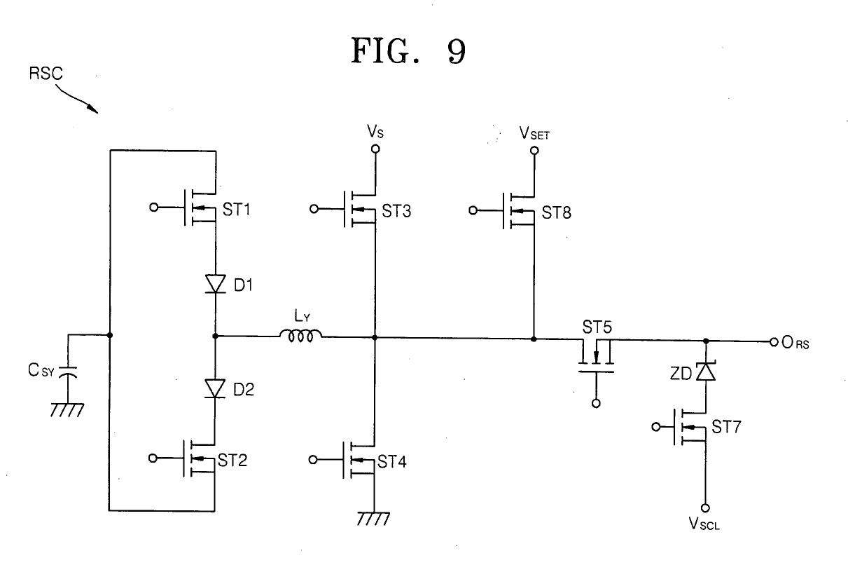

FIG. 8 shows a scan driving circuit (AC) and a switching output circuit (SIC) of the Y-driving unit 45 in the driving apparatus of FIG. 4. In FIG. 8, plasma display panel 1 is simply illustrated as being disposed between the Y-driving unit 45 and the X-driving unit 44 in order to explain the principles of the operation. Referring to FIG. 8, the Y-driving unit 45 of the present embodiment includes a reset/sustain circuit (RSC), a scan driving circuit (AC), and a switching output circuit (SIC).

The reset/sustain circuit (RSC) generates driving signals that are to be applied to the Y electrode lines (Y₁, . . . , Yₙ) in the reset period (I of FIG. 5) and the sustain period (S of FIG. 5). The scan driving circuit (AC) generates driving signals that are to be applied to the Y electrode lines (Y₁, . . . , Yₙ) in the addressing period (A of FIG. 5). In the switching output circuit (SIC), upper transistors (YU1, . . . , YUn) and lower transistors (YL1, . . . , YLn) are arranged so that a common output line of each of the upper transistors and each of the lower transistors is connected to a corresponding one of the Y electrode lines (Y₁, . . . , Yₙ). The switching control signals from the controller 42 are applied to gates that are controlling terminals of the upper transistors (YU1, . . . , YUn) and the lower transistors (YL1, . . . , YLn) through driving buffers (not shown).

Operations of the Y-driving unit of FIG. 8 will be described as follows with reference to FIGS. 5 and 8. In the addressing period (A), a scan-potential transistor (S_{SCL}) of the scan driving circuit (AC) is in turn-on state. Accordingly, the negative fourth potential (V_{SCL}) that is the potential of the scan pulse is applied to the lower transistors (YL1, . . . , YLn) of the switching output circuit (SIC) through the scan-potential transistor (S_{SCL}). In addition, the third potential (V_{SCH}) that is the scan-bias potential is applied to the upper transistors (YU1, . . . , YUn) of the switching output circuit (SIC) through a diode (D_{M}). Therefore, in the addressing period (A), a voltage that is a difference (|V_{SCL}−V_{SCH}|) between the fourth potential (V_{SCL}) and the third potential (V_{SCH}) is applied to a maximum power capacitor (C_{M}) of the scan driving circuit (AC).

In the above state, a lower transistor is turned on and an upper transistor is turned off, and the lower and upper transistors are connected to a Y electrode line that is to be scanned. Alternatively, lower transistors are turned off and upper transistors are turned on, and the lower and upper transistors are connected to other Y electrode lines. Accordingly, the fourth potential (V_{SCL}) that is the potential of the scan pulse is applied to one Y electrode line that is to be scanned, and the third potential (V_{SCH}) that is the scan-bias potential is applied to the other Y electrode lines.

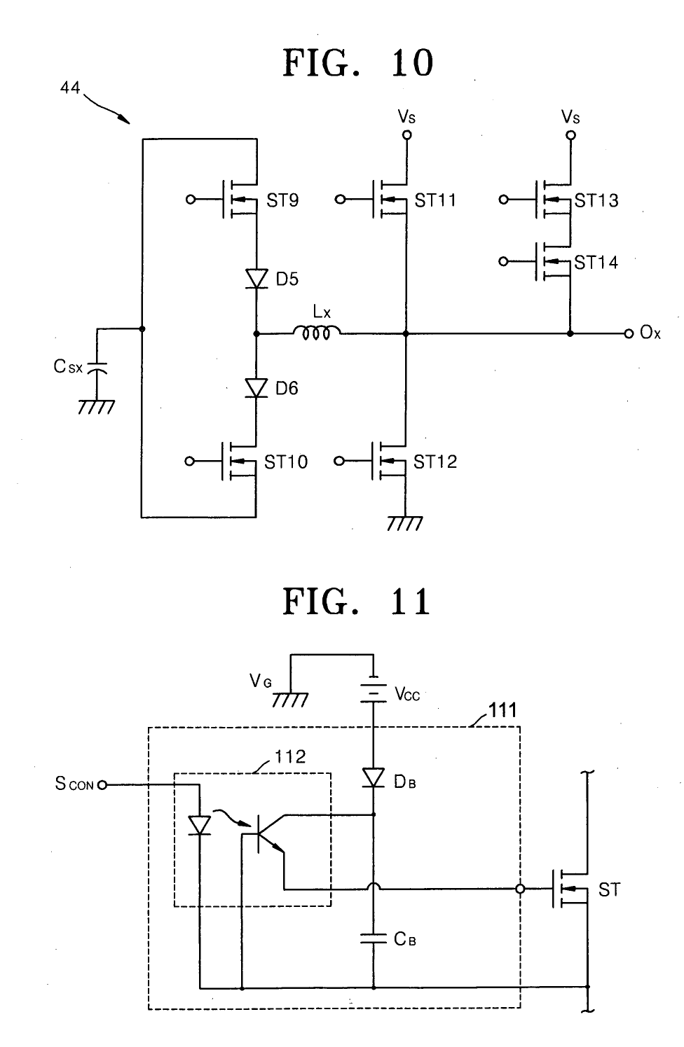

Operations in the reset period (I) and the sustain period (S) will be described with reference to the reset/sustain circuit (RSC) of FIG. 9. In addition, an operation of applying an output (O_{X}) of the X-driving unit 44 to the X electrode lines (X₁, . . . , Xₙ) will be described with reference to FIG. 10.

FIG. 9 shows the reset/sustain circuit (RSC) of FIG. 8. The reset/sustain circuit (RSC) of FIG. 9 operates as follows with reference to FIGS. 5, 8, and 9. In the potential rising period (t51˜t52) included in the reset period (I) of the unit sub-field (SF), when the scan-potential transistor (S_{SCL}) of the scan driving circuit (AC) is turned on, an initial potential of the maximum power capacitor (C_{M}) rises to the positive fifth potential (|V_{SCL}−V_{SCH}|) that is the magnitude of the difference between the fourth potential (V_{SCL}) and the third potential (V_{SCH}). In addition, the lower transistors (YL1, . . . , YLn) of the switching output circuit (SIC) are turned off and the upper transistors (YU1, . . . , YUn) of the switching output circuit (SIC) are turned on, and then, the positive fifth potential (|V_{SCL}−V_{SCH}|) is applied to the Y electrode lines (Y₁, . . . , Yₙ).

As described above, during the period from the point when the positive fifth potential (|V_{SCL}−V_{SCH}|) is applied to the Y electrode lines (Y₁, . . . , Yₙ) to the end of the potential rising period (t51˜t52), the scan-potential transistor (S_{SCL}) of the switching output circuit (SIC) is turned off and a fifth transistor (ST5) of the reset/sustain circuit (RSC) is turned on. In addition, since the positive control potential that increases gradually is applied to a base of an eighth transistor (ST8), the potential of the Y electrode lines (Y₁, . . . , Yₙ) continuously rises from the fifth potential (|V_{SCL}−V_{SCH}|) to the first potential (V_{SET}+|V_{SCL}−V_{SCH}|) that is the sixth potential (V_{SET}) higher than the fifth potential (|V_{SCL}−V_{SCH}|).

In the first potential descending period (t52˜t53) of the reset period (I), in a state where the fifth transistor (ST5) of the reset/sustain circuit (RSC) is turned on, the upper transistors (YU1, . . . , YUn) of the switching output circuit (SIC) and the eighth transistor (ST8) of the reset/sustain circuit (SRC) are turned off, and the lower transistors (YL1, . . . , YLn) of the switching output circuit (SIC) and the fourth transistor (ST4) of the reset/sustain circuit (SRC) are turned on.

Accordingly, the potential applied to the Y electrode lines (Y₁, . . . , Yₙ) descends from the first potential (V_{SET}+|V_{SCL}−V_{SCH}|) to the ground potential (V_{G}).

In the second potential descending period (t53˜t54) of the reset period (I), the fourth transistor (ST4) and the fifth transistor (ST5) of the reset/sustain circuit (RSC) are turned off, and a positive potential that gradually increases is applied to the gate of a seventh transistor (ST7) as a reset-descending switch, and thus, a channel resistance of the seventh transistor (ST7) is reduced. Accordingly, the potential applied to the Y electrode lines (Y₁, . . . , Yₙ) continuously descends from the ground potential (V_{G}) to the negative second potential (V_{F}). At the end of the potential descending period (t52˜t53) of the reset period, the second potential (V_{F}) is applied to the Y electrode lines (Y₁, . . . , Yₙ) only when the descending potential switch (ST7) is turned on. Here, the second potential (V_{F}) is a reverse breakdown voltage of a zener diode (ZD) higher than the fourth potential (V_{SCL}).

In the addressing period (A), all transistors (ST1 through ST8) of the reset/sustain circuit (RSC) are turned off, and thus, an output end (O_{RS}) of the reset/sustain circuit (RSC) is electrically floated.

In the sustain period (S), the upper transistors (YU1, . . . , YUn) of the switching output circuit (SIC) are turned off, and the lower transistors (YL1, . . . , YLn) are turned on. In addition, operations of the reset/sustain circuit (RSC) are as follows.

In a unit pulse applied to all of the Y electrode lines (Y₁, . . . , Yₙ), the second and fifth transistors (ST2 and ST5) are turned on while the voltage descends from the seventh potential (V_{S}) to the ground potential (V_{G}). Accordingly, electric charges remaining in the display cells (electric capacitors) are collected into a power recycling capacitor (C_{SY}). The collected charges are applied to all of the Y electrode lines (Y₁, . . . , Yₙ) while the voltage rises from the ground voltage (V_{G}) to the seventh potential (V_{S}) to be re-used. This process will be described in more detail as follows.

In the unit pulse applied to all of the Y electrode lines (Y₁, . . . , Yₙ) in the sustain period (S), the second and fifth transistors (ST2 and ST5) are turned on while the voltage descends from the seventh potential (V_{S}) to the ground potential (V_{G}). Accordingly, the charges collected in the power recycling capacitor (C_{SY}) are applied to all of the Y electrode lines (Y₁, . . . , Yₙ) through the first transistor (ST1), a first diode (D1), a tuning coil (L_{Y}), the fifth transistor (ST5), and the output end (O_{RS}).

Next, the third and fifth transistors (ST3, ST5) are turned on, and thus, the seventh potential (V_{S}) is applied to all of the Y electrode lines (Y₁, . . . , Yₙ). Here, the third and fifth transistors (ST3, ST5) are turned on when the sustain pulses stops rising.

Next, only the second and fifth transistors (ST2 and ST5) are turned on while the voltage descends from the seventh potential (V_{S}) to the ground potential (V_{G}). Accordingly, the charges remaining in the display cells (electric capacitors) are collected into the power recycling capacitor (C_{SY}) through the output end (O_{RS}), the fifth transistor (ST5), the tuning coil (L_{Y}), a second diode (D2), and the second transistor (ST2).

Finally, only the fourth and fifth transistors (ST4 and ST5) are turned on, and thus, the ground potential (V_{G}) is applied to all of the Y electrode lines (Y₁, . . . , Yₙ).

FIG. 10 shows an internal circuit of the X-driving unit 44 in the driving apparatus of FIG. 4. Operations of the X-driving unit 44 will be described as follows with reference to FIGS. 5, 8, and 10.

In the reset period (I) of the unit sub-field (SF), when only a twelfth transistor (ST12) is turned on in the potential rising period (t51˜t52), the output signal (O_{X}) changes to have the ground potential (V_{G}).

Next, in the first potential descending period (t52˜t53) of the reset period (I) and in the addressing period (A), only thirteenth and fourteenth transistors (ST13 and ST14) are turned on, and thus, the potential of the output signal (O_{X}) changes to be the ninth potential (V_{E}).

In the unit pulse applied to all of the X electrode lines (X₁, . . . , Xₙ) in the sustain period (S), only a tenth transistor (ST10) is turned on while the voltage descends from the seventh potential (V_{S}) to the ground potential (V_{G}). Accordingly, electric charges remaining in the display cells (electric capacitors) are collected in the power recycling capacitor (C_{SX}). The collected charges are applied to all of the X electrode lines (X₁, . . . , Xₙ) while the voltage rises from the ground potential (V_{G}) to the seventh potential (V_{S}) to be re-used. This process will be described in detail as follows.

In the unit pulse applied to all of the X electrode lines (X₁, . . . , Xₙ) in the sustain period (S), only the ninth transistor (ST9) is turned on while the voltage rises from the ground potential (V_{G}) to the seventh potential (V_{S}). Accordingly, the charges collected in the power recycling capacitor (C_{SX}) are applied to all of the X electrode lines (X₁, . . . , Xₙ) through the ninth transistor (ST9), a fifth diode (D5), the tuning coil (L_{X}), and the output end (O_{X}).

Next, only an eleventh transistor (ST11) is turned on, the seventh potential (V_{S}) is applied to all of the X electrode lines (X₁, . . . , Xₙ). Here, the eleventh transistor (ST11) is turned on when the sustain pulses stop rising.

Next, only a tenth transistor (ST10) is turned on while the voltage descends from the seventh potential (V_{S}) to the ground potential (V_{G}). Accordingly, the charges remaining in the display cells (electric capacitors) are collected in the power recycling capacitor (C_{SX}) through the tuning coil (L_{X}), a sixth diode (D6), and the tenth transistor (ST10).

Finally, only the twelfth transistor (ST12) is turned on, and thus, the ground potential (V_{G}) is applied to all of the X electrode lines (X₁, . . . , Xₙ).

FIG. 11 shows a driving buffer 111 for grounding a source potential of each of the field effect transistors (STs) having no grounding end in FIGS. 8 through 10. Referring to FIG. 11, the driving buffer 111 includes a photocoupler 112, a diode, and a Bootstrap capacitor (C_{B}).

The photocoupler 112 performing a noise removal function operates according to a control signal (S_{CON}) to generate a gate driving signal of each of the field effect transistors (STs). The diode (D_{B}) prevents the electric current from flowing to the grounding end through a direct current (DC) power (V_{CC}) due to the voltage charged in the Bootstrap capacitor (C_{B}). When the source of each field effect transistor (ST) is grounded once during the initialization time from when the electric power is applied, the Bootstrap capacitor (C_{B}) is charged. Accordingly, the ground potential (V_{G}) of the source in the each field effect transistor (ST) is maintained, and when the photocoupler 112 is turned on, each of the field effect transistors (STs) can be turned on by the DC power (V_{CC}).

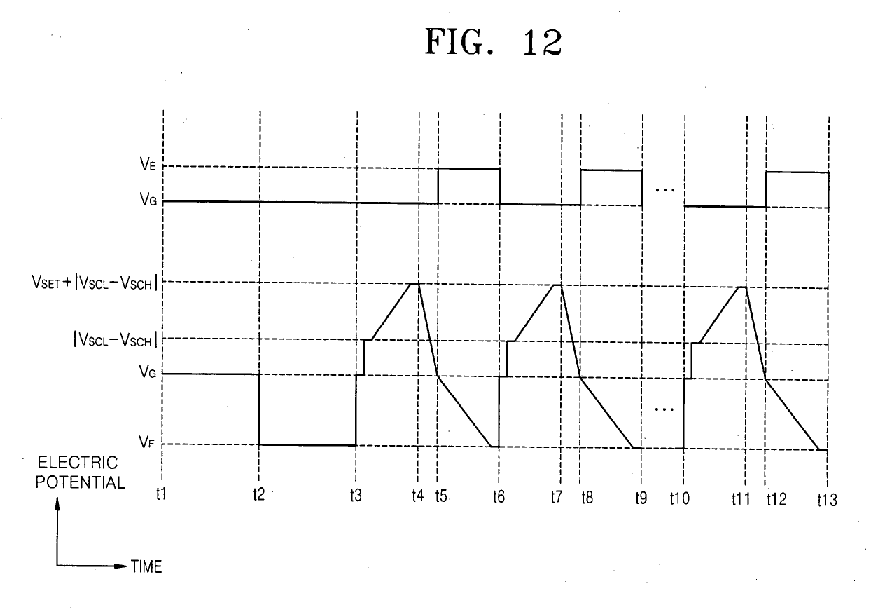

FIG. 12 shows a first example of driving signals applied to the X electrode lines (X₁, . . . , Xₙ) and the Y electrode lines (Y₁, . . . , Yₙ), in which temperature of the plasma display panel 1 of FIG. 1 is in a normal temperature range, that is, a first temperature range. In the present invention, an example of the normal temperature range can be 20° C. to 30° C., which can be a temperature measured when electric power is initially applied to the discharge display panel. The present invention focuses on optimizing driving signals when temperature of a discharge display panel is higher or lower than normal temperature range. Therefore, the normal temperature range can be a range that is initially determined, and is not limited to the range of above example. Once the normal temperature range is determined, it is determined whether the temperature of the discharge display panel is higher or lower than the normal temperature range, and if the temperature is out of the normal temperature range, the driving signal changes to be optimized according to the temperature. Herein, the temperature of the plasma display panel is temperature around surface of the plasma display panel. In FIG. 12, an upper signal denotes an initialization signal applied to the X electrode lines (X₁, . . . , Xₙ) and a lower signal denotes an initialization signal applied to the Y electrode lines (Y₁, . . . , Yₙ). In FIG. 12, the same reference numerals as those of FIG. 5 denote the same elements.

Referring to FIGS. 8, 9, 11, and 12, in a first time period (t1˜t2), the fourth transistor (ST4), the fifth transistor (ST5), and lower transistors (YL1, . . . , YLn) are turned on. Accordingly, the Bootstrap capacitors (C_{B}) of the field effect transistors having no grounding end, for example, the first transistor (ST1), the third transistor (ST3), and the eighth transistor (ST8), are charged. When the fourth transistor (ST4) is turned on, the ground potential (V_{G}) is applied to the Y electrode lines (Y₁, . . . , Yₙ).

In a second time period (t2˜t3), the seventh transistor (ST7) and the lower transistors (YL1, . . . , YLn) are turned on. Accordingly, the Bootstrap capacitors (C_{B}) of the field effect transistor having no grounding end, for example the fifth transistor (ST5), are charged. When the seventh transistor (ST7) is turned on, the negative second potential (V_{F}) is applied to the Y electrode lines (Y₁, . . . , Yₙ).

In the potential rising period (t3˜t4), the electric potential applied to the Y electrode lines (Y₁ . . . , Yₙ) rises continuously from the fifth potential (|V_{SCL}−V_{SCH}|) to a first potential (V_{SET}+|V_{SCL}−V_{SCH}|), which is higher than the fifth potential (|V_{SCL}−V_{SCH}|) by a sixth potential (V_{SET}). For example, the fifth potential (|V_{SCL}−V_{SCH}|) can be 120 V, the first potential (V_{SET}+|V_{SCL}−V_{SCH}|) can be 315 V, and the sixth potential (V_{SET}) can be 195 V. Here, the fifth potential (V_{SCL}−V_{SCH}|) is a positive potential which has the magnitude of a difference between a third potential (V_{SCH}) as a scan-bias potential, for example, −70V, and a fourth potential (V_{SCL}) as a scan potential, for example, −190V. The ground potential (V_{G}) is applied to the X electrode lines (X₁, . . . , Xₙ) and the address electrode lines (A_{R1}, . . . , A_{Bm}).

Accordingly, the discharges occur between the Y electrode lines (Y₁, . . . , Yₙ) and the X electrode lines (X₁, . . . , Xₙ), and also occur between the Y electrode lines (Y₁, . . . , Yₙ) and the address electrode lines (A_{R1}, . . . , A_{Bm}). Therefore, negative wall charges are formed around the Y electrode lines (Y₁, . . . , Yₙ), positive wall charges are formed around the X electrode lines (X₁, . . . , Xₙ), and positive wall charges are formed around the address electrode lines (A_{R1}, . . . , A_{Bm}) (refer to FIG. 6).

Next, in the first potential descending period (t4˜t5), in which the electric potential applied to the X electrode lines (X₁, . . . , Xₙ) and to the address-electrode lines (A_{R1}, . . . , A_{Bm}) is maintained as the ground potential (V_{G}), the electric potential applied to the Y electrode lines (Y₁, . . . , Yₙ) rapidly descends from the first potential to the ground potential (V_{G}).

In the second potential descending period (t5˜t6), in which the potential applied to the X electrode lines (X₁, . . . , Xₙ) is maintained as the ninth potential (V_{E}), for example, 110 V, the potential applied to the Y electrode lines (Y₁, . . . , Yₙ) descends slowly from the ground potential (V_{G}) to the negative second potential (V_{F}), for example, −170 V. Here, the ground potential (V_{G}) is applied to the address electrode lines (A_{R1}, . . . A_{Bm}).

During the first and second potential descending periods (t4˜t6), some of the negative wall charges around the Y electrode lines (Y₁, . . . , Yₙ) move towards the X electrode lines (X₁, . . . , Xₙ) due to the discharges between the X electrode lines (X₁, . . . , Xₙ) and the Y electrode lines (Y₁, . . . , Yₙ) In addition, since the ground voltage (V_{G}) is applied to the address electrode lines (A_{R1}, . . . , A_{Bm}), more positive wall charges are formed around the address electrode lines (A_{R1}, . . . , A_{Bm}) (refer to FIG. 7).

The potential rising period (t3˜t4) and the potential descending periods (t4˜t6) can be repeated in following the time period such as t6˜t9.

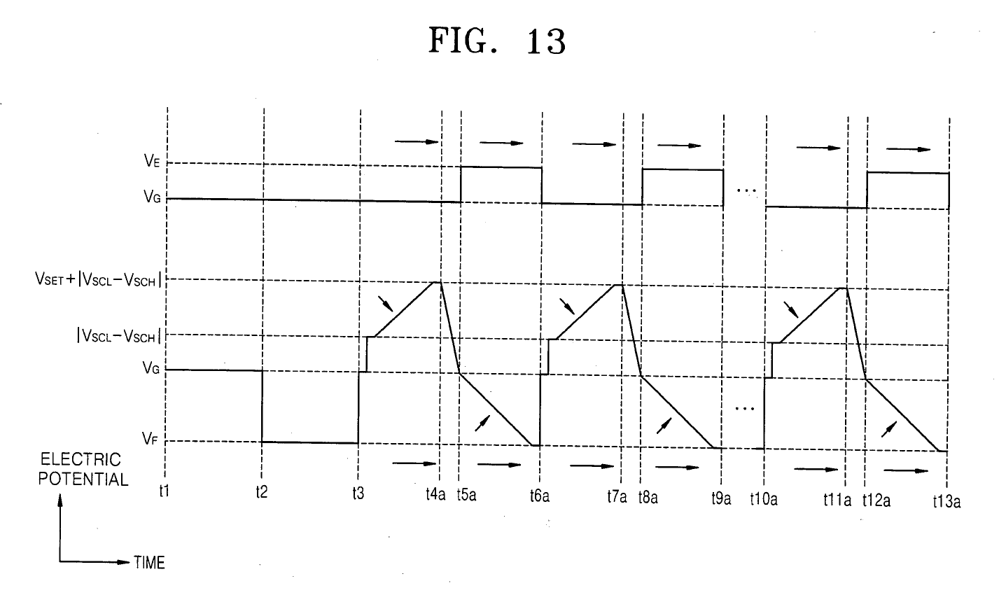

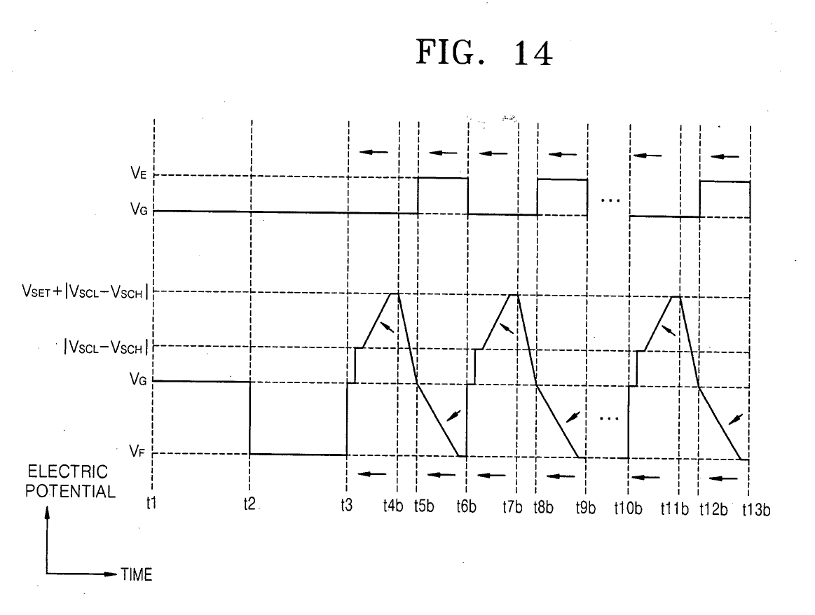

FIG. 13 shows a first example of driving signals applied to the X electrode lines (X₁, . . . , Xₙ) and the Y electrode lines (Y₁, . . . , Yₙ), in which temperature of the plasma display panel 1 of FIG. 1 is in a lower temperature range, that is, a second temperature range. The same reference numerals as those of FIG. 12 denote the same elements.

Referring to FIG. 12, which is the case that the temperature around the plasma display panel (1 of FIG. 1) is in the normal temperature range, that is, the first temperature range, the voltage rises in the potential rising period (for example, t3˜t4) at a first rising rate with respect to time, and the voltage descends at a first descending rate with respect to time in the second potential descending period (for example, t5˜t6).

On the other hand, referring to FIG. 13, which is the case that the temperature around the plasma display panel (1 of FIG. 1) is in a lower temperature range, that is, the second temperature range, the voltage rises at a second rising rate, which is smaller than the first rising rate, in the potential rising period (for example, t3˜t4a), and the voltage descends at a second descending rate, which is smaller than the first descending rate, in the second potential descending period (for example, t5a˜t6a).

Accordingly, this driving scheme solves the problem that the strong and rapid discharge occurs more easily than the weak and slow discharge in the lower temperature.

Referring to FIG. 13, the maximum (or peak) voltage of the rising voltage signal is fixed to the first potential (V_{SET}+|V_{SCL}−V_{SCH}|). In other words, the peak voltage of the rising voltage signal in the lower temperature range is the same as the peak voltage of the rising voltage signal in the normal temperature range. Time interval for applying the rising voltage and the descending voltage is increased. A first application time is sum of the potential rising period (t3-t4) and the second potential descending period (t5˜t6), which is required in the normal temperature range (FIG. 12), and a second application time is sum of the potential rising period (t3˜t4a) and the second potential descending period (t5a˜t6a), which is required in the lower temperature range (FIG. 13). Therefore, the second application time is longer than the first application time. The change of application time is controlled by an internal clock installed in the controller 42 shown in FIG. 4. Herein, the potential rising period of the first application time is referred to as a first rising application period, and the potential descending period of the first application time is referred to as a first descending application period. The potential rising period of the second application time is referred to as a second rising application period, and the potential descending period of the second application time is referred to as a second descending application period.

FIG. 14 shows a first example of driving signals applied to the X electrode lines (X₁, . . . , Xₙ) and the Y electrode lines (Y₁, . . . , Yₙ) in a case that temperature around the plasma display panel 1 is in a higher temperature range, that is, a third temperature range. In FIG. 14, the same reference numerals as those of FIG. 12 denote the same elements.

Referring to FIG. 12, which is the case that the temperature around the plasma display panel 1 (FIG. 1) is in the normal temperature range (the first temperature range), the voltage rises at the first rising rate with respect to time in the potential rising period (for example, t3˜t4), and the voltage descends at the first descending rate with respect to time in the second potential descending period (for example, t5˜t6).

On the other hand, referring to FIG. 14, which is the case that the temperature around the plasma display panel (1 of FIG. 1) is in the higher temperature range, that is, the third temperature range, the voltage rises at a third rising rate, which is greater than the first rising rate, in the potential rising period (for example, t3˜t4b), and the voltage descends at a third descending rate, which is greater than the first descending rate in the second potential descending period (for example, t5b˜t6b).

Accordingly, this driving scheme solves the problem that the weak and slow discharge occurs more easily than the strong and rapid discharge in the higher temperature.

In FIG. 14, a maximum (or peak) voltage of the rising voltage is fixed to the first potential (V_{SET}+|V_{SCL}−V_{SCH}|). In other words, the peak voltage of the rising voltage signal in the higher temperature range is the same as the peak voltage of the rising voltage signal in the normal temperature range. The time interval required for applying the rising voltage and the descending voltage is reduced. A third application time, which is sum of the potential rising period (t3˜t4b) and the second potential descending period (t5b˜t6b), which is required in the higher temperature range (FIG. 14), is smaller than the first application time, which is required in the normal temperature range (FIG. 12). The first application time is defined as sum of the potential rising period (t3-t4) and the second potential descending period (t5-t6). Herein, the potential rising period of the third application time is referred to as a third rising application period, and the potential descending period of the third application time is referred to as a third descending application period.

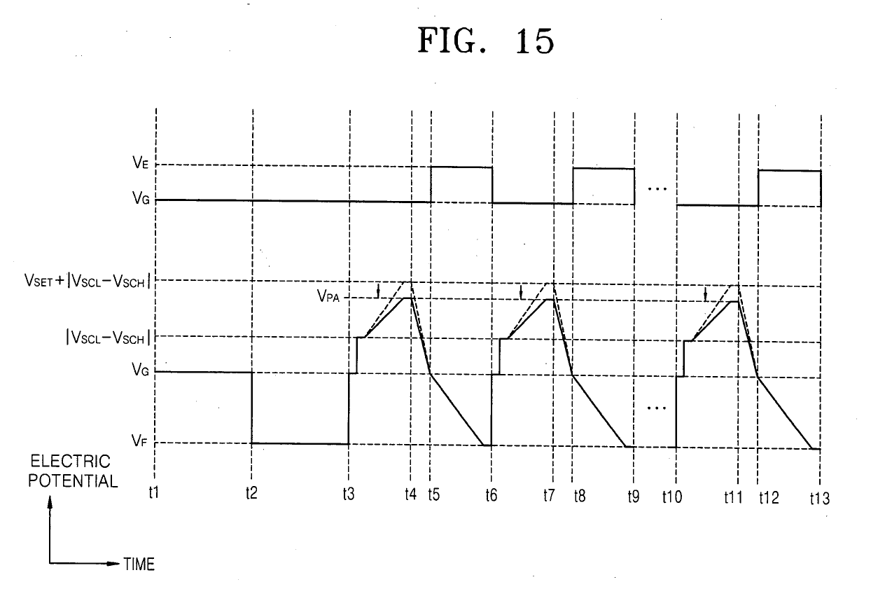

FIG. 15 shows a second example of driving signals applied to the X electrode lines (X₁, . . . , Xₙ) and the Y electrode lines (Y₁, . . . , Yₙ) in a case that temperature around the plasma display panel 1 of FIG. 1 is in a lower temperature range, that is, a second temperature range. In FIG. 15, the same reference numerals as those of FIG. 12 denote the same element.

Referring to FIG. 12, which is the case that the temperature around the plasma display panel (1 of FIG. 1) is in the normal temperature range (the first temperature range), the voltage rises at the first rising rate with respect to time in the potential rising period (for example, t3˜t4).

On the other hand, referring to FIG. 15, which is the case that the temperature around the plasma display panel (1 of FIG. 1) is in the lower temperature range (the second temperature range), the voltage rises at the second rising rate, which is lower than the first rising rate, in the potential rising period (for example, t3˜t4). However, in this case, the change in the rising rate is achieved by adjusting the peak voltage of the rising voltage signal. As shown in FIG. 15, the application time (sum of t3˜t4 and t5˜t6) in the lower temperature range is the same as the application time in the normal temperature range, but the peak voltage is different. In FIG. 15, the application times (for example, t3˜t4 or t5˜t6) required for applying the rising voltage and the descending voltage are fixed as a constant, and the peak voltage V_{PA} (or a second peak voltage) of the rising voltage, which is lower than the first peak voltage (V_{SET}+|V_{SCL}−V_{SCH}|), is applied. That is, a first peak voltage (V_{SET}+|V_{SCL}−V_{SCH}|) is applied in the normal temperature range (FIG. 12), and a second peak voltage (V_{PA}), which is lower than the first peak voltage (V_{SET}+|V_{SCL}−V_{SCH}|), is applied in the low temperature range (FIG. 15).

Accordingly, the change of the peak voltage provide a similar effect on the rising rate, and this driving scheme solves the problem that the strong and rapid discharge occurs more easily than the weak and slow discharge in the lower temperature.

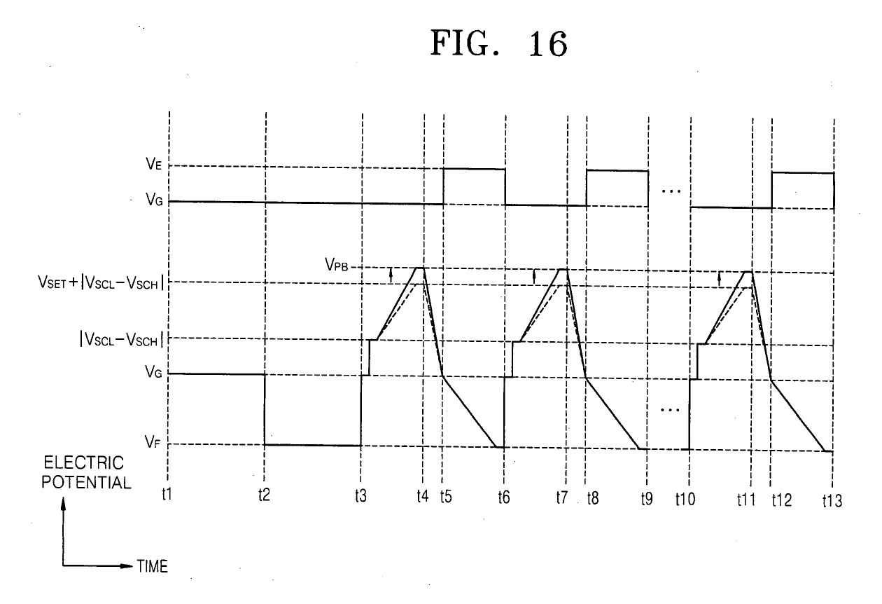

FIG. 16 shows a second example of driving signals applied to the X electrode lines (X₁, . . . , Xₙ) and the Y electrode lines (Y₁, . . . , Yₙ) in a case that the temperature around the plasma display panel 1 of FIG. 1 is in a higher temperature range, that is, a third temperature range. In FIG. 16, the same reference numerals as those of FIG. 12 denote the same elements.

Referring to FIG. 12, which is the case that the temperature around the plasma display panel (1 of FIG. 1) is in the normal temperature range (the first temperature range), the voltage rises at the first rising rate with respect to time in the potential rising period (for example, t3˜t4).

On the other hand, referring to FIG. 16, which is the case that the temperature around the plasma display panel (1 of FIG. 1) is in the higher temperature range (the third temperature range), the voltage rises at the third rising rate, which is higher than the first rising rate, in the potential rising period (for example, t3˜t4).

In FIG. 16, the application times (for example, t3˜t4 or t5˜t6) for applying the rising voltage and the descending voltage are fixed as a constant, and the third peak voltage (V_{PB}) of the rising voltage is increased. That is, a first peak voltage (V_{SET}+|V_{SCL}−V_{SCH}|) is applied in the normal temperature range (FIG. 12), and a third peak voltage (V_{PB}), which is higher than the first peak voltage (V_{SET}+|V_{SCL}−V_{SCH}|), is applied in the low temperature range (FIG. 16). Accordingly, this driving scheme solves the problem that the weak and slow discharge occurs more easily than the strong and rapid discharge in the higher temperature.

The change of the peak voltage among the first peak voltage (V_{SET}+|V_{SCL}−V_{SCH}|), the second peak voltage (V_{PA}), and the third peak voltage (V_{PB}) can be accomplished by changing the magnitude of the sixth potential (V_{SET}) shown in FIG. 9. For example, in FIG. 9, two additional transistors, which are substantially identical to the eighth transistor (ST8), can be connected parallel to the eighth transistor (ST8). The three eighth transistors are referred to as a first-eighth transistor, a second-eighth transistor, and a third-eighth transistor. Three different sixth potentials V_{SET1}, V_{SET2}, and V_{SET3} are applied to the first-eighth transistor, second-eighth transistor, and third-eighth transistor, respectively. By turning on only one transistor among the first-eighth, second-eighth, and third-eighth transistors, one of the sixth potentials V_{SET1}, V_{SET2}, and V_{SET3} is supplied. The controller shown in FIG. 4 controls the selection for turning on one of the first-eighth, second-eighth, and third-eighth transistors depending on the temperature data of the plasma display panel.

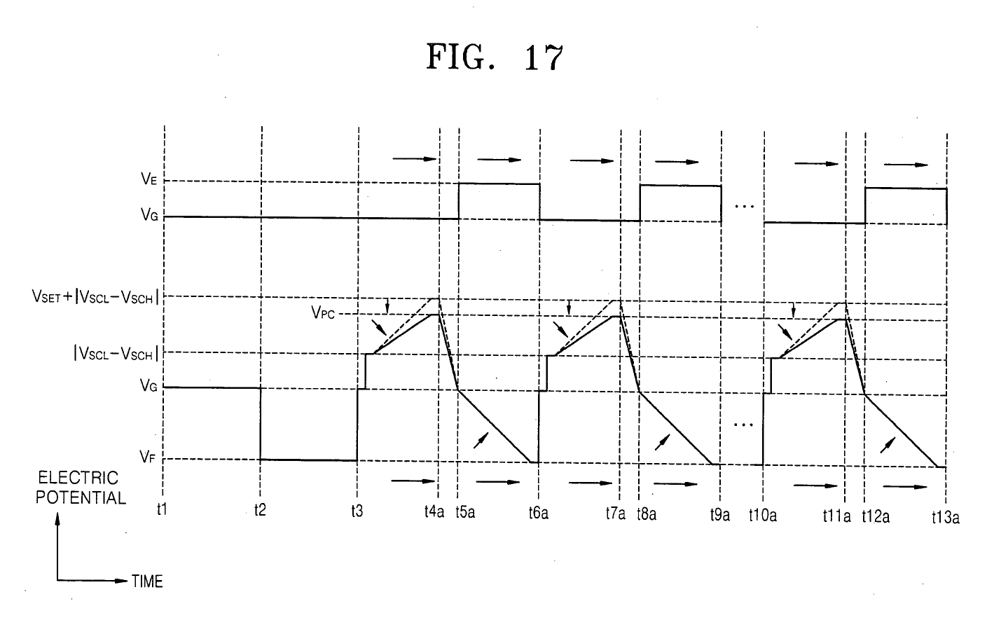

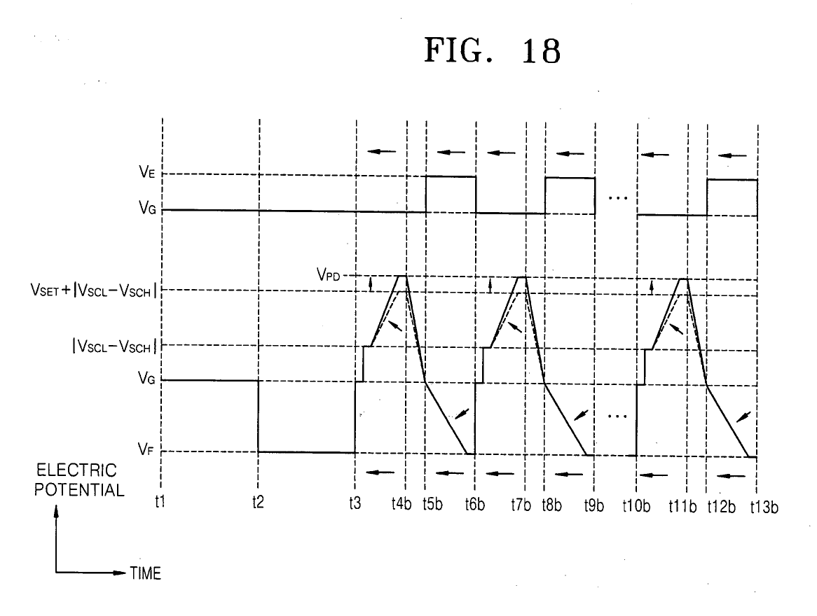

FIG. 17 shows a third example of driving signals applied to the X electrode lines (X₁, . . . , Xₙ) and the Y electrode lines (Y₁, . . . , Yₙ) in a case that the temperature around the plasma display panel 1 of FIG. 1 is in the lower temperature range (the second temperature range). In FIG. 17, the same reference numerals as those of FIG. 12 denote the same elements.

Referring to FIG. 12, in a case where the temperature around the plasma display panel (1 of FIG. 1) is in the normal temperature range (the first temperature range), the voltage rising at the first rising rate with respect to time is applied in the potential rising period (for example, t3˜t4).

On the other hand, referring to FIG. 17, in a case where the temperature around the plasma display panel (1 of FIG. 1) is in the lower temperature range (the second temperature range), the voltage rising at the second rising rate, which is lower than the first rising rate, is applied in the potential rising period (for example, t3˜t4a), and the voltage descending at the second descending rate, which is lower than the first descending rate, is applied in the second potential descending period (for example, t5a˜t6a). In this case, both of the peak voltage and the application time are changed. Accordingly, the problem wherein strong and rapid discharge occurs and weak and slow discharge does not occur in the low temperature range, can be solved.

In FIG. 17, the maximum voltage (V_{PC}) of the rising voltage is reduced, and the times for applying the rising voltage and the descending voltage (for example, t3˜t4a or t5a˜t6a) are increased. That is, the first maximum voltage (V_{SET}+|V_{SCL}−V_{SCH}|) and the first application time (for example, t3˜t4 or t5˜t6) is applied (FIG. 12) in the normal temperature range, and the second maximum voltage (V_{PC}) that is lower than the first maximum voltage (V_{SET}+|V_{SCL}−V_{SCH}|) and the second application time (for example, t3˜t4a or t5a˜t6a) that is longer than the first application time (for example, t3˜t4 or t5˜t6) are applied in the low temperature range (FIG. 17).

FIG. 18 shows a third example of driving signals applied to the X electrode lines (X₁, . . . , X₁) and the Y electrode lines (Y₁, . . . , Yₙ) in a case where the temperature around the plasma display panel 1 of FIG. 1 is in the higher temperature range, that is, the third temperature range. In FIG. 18, the same reference numerals as those of FIG. 12 denote the same elements.

Referring to FIG. 12, in a case where the temperature around the plasma display panel (1 of FIG. 1) is in the normal temperature range, that is, the first temperature range, the voltage rising at the first rising rate with respect to time is applied in the potential rising period (for example, t3 ˜t4).

On the other hand, referring to FIG. 18, in a case where the temperature around the plasma display panel (1 of FIG. 1) is included in the high temperature range, that is, the third temperature range, the voltage rising at the third rising rate that is higher than the first rising rate is applied in the potential rising period (for example, t3˜t4b), and the voltage descending at the third descending rate that is higher than the first descending rate is applied in the second potential descending period (for example, t5b˜t6b).

Accordingly, the problem wherein weak and slow discharge occurs and strong and rapid discharge does not occur in the high temperature range, can be solved.

In FIG. 18, the maximum voltage (V_{PD}) of the rising voltage is increased, and the times for applying the rising voltage and the descending voltage (for example, t3˜t4b or t5b˜t6b) are reduced. That is, the first maximum voltage (V_{SET}+|V_{SCL}−V_{SCH}|) and the first application time (for example, t3˜t4 or t5˜t6) are applied (FIG. 12) in the normal temperature range, and the second maximum voltage (V_{PD}) that is higher than the first maximum voltage (V_{SET}+|V_{SCL}−V_{SCH}|) and the third application time (for example, t3˜t4b or t5b˜t6b) that is shorter than the first application time (for example, t3˜t4 or t5˜t6) are applied in the high temperature range (FIG. 18).

As described above, according to the method of driving the discharge display panel of the present invention, when the temperature around the discharge display panel is lowered, the rates of changing the rising voltage and/or the descending voltage are lowered. Accordingly, the problem wherein weak and slow discharge does not occur while strong and rapid discharge occurs well in the low temperature range, can be solved.

On the other hand, when the temperature around the discharge display panel is increased, the rates of changing the rising voltage and/or the descending voltage are increased. Accordingly, the problem wherein strong and rapid discharge does not occur while weak and slow discharge occurs well in the high temperature range, can be solved.

That is, the strong and rapid discharge occurs sufficiently while the weak and slow discharge also occurs sufficiently without being dependant on the temperature around the discharge display panel. That is, the discharge can occur in synchronization in all of the discharge cells having different discharging conditions from each other. Therefore, the display cells can be initialized stably in the initialization time from the point when the electric power is applied, and thus, the display can be performed sufficiently at the initial stage of driving the panel.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of driving a discharge display panel, the method comprising:
detecting temperature around the discharge display panel; and
applying a reset driving signal to all display cells in the discharge display panel, the reset driving signal setting the all display cells on an identical condition for discharge, the reset driving signal including a rising voltage signal and a descending voltage signal, the step of applying the reset driving signal comprising:
adjusting a rising rate of the rising voltage signal and a descending rate of the descending voltage signal in dependence on the temperature;
applying the rising voltage signal during a rising application period; and
applying the descending voltage signal during a descending application period.

2. The method of claim 1, further comprising:
repeatedly applying the set of the rising voltage signal and the descending voltage signal to the discharge display panel.

3. The method of claim 1, wherein
the step of applying the rising voltage signal comprises:
applying the rising voltage signal at a first rising rate if the temperature is in a first temperature range; and
applying the rising voltage signal at a second rising rate if the temperature is below the first temperature range, the second rising rate being smaller than the first rising rate; and
the step of applying the descending voltage signal comprises:
applying the descending voltage signal at a first descending rate if the temperature is in the first temperature range; and
applying the descending voltage signal at a second descending rate if the temperature is below the first temperature range, the second descending rate being smaller than the first descending rising rate.

4. The method of claim 3, wherein
the step of applying the rising voltage signal includes a step of applying the rising voltage signal at a third rising rate if the temperature is above the first temperature range, the third rising rate being greater than the first rising rate; and
the step of applying the descending voltage signal includes a step of applying the descending voltage signal at a third descending rate if the temperature is above the first temperature range, the third descending rate being greater than the first descending rising rate.

5. The method of claim 4, wherein a peak voltage of the rising voltage signal is set as a constant regardless of the temperature.

6. The method of claim 5, wherein the step of applying the rising voltage signal includes:
applying the rising voltage signal during a first rising application period if the temperature is in a first temperature range;
applying the rising voltage signal during a second rising application period if the temperature is below the first temperature range, the second rising application period being longer than the first rising application period; and
applying the rising voltage signal during a third rising application period if the temperature is above the first temperature range, the third rising application period being shorter than the first rising application period.

7. The method of claim 5, wherein the step of applying the descending voltage signal includes:
applying the descending voltage signal during a first descending application period if the temperature is in a first temperature range;
applying the descending voltage signal during a second descending application period if the temperature is below the first temperature range, the second descending application period being longer than the first descending application period; and
applying the rising voltage signal at a third descending application period if the temperature is above the first temperature range, the third descending application period being shorter than the first descending application period.

8. The method of claim 4, wherein each of the rising application period and the descending application period is set as a constant regardless of the temperature.

9. The method of claim 8, wherein
the rising voltage signal has a first peak voltage if the temperature is in a first temperature range;
the rising voltage signal has a second peak voltage if the temperature is below the first temperature range, the second peak voltage being smaller than the first peak voltage; and
the rising voltage signal has a third peak voltage if the temperature is above the first temperature range, the third peak voltage being greater than the first peak voltage.

10. The method of claim 4, wherein the step of applying the rising voltage signal includes:
applying the rising voltage signal having a first peak voltage during a first rising application period if the temperature is in a first temperature range;
applying the rising voltage signal having a second peak voltage during a second rising application period if the temperature is below the first temperature range, the second rising application period being longer than the first rising application period, the second peak voltage being smaller than the first peak voltage; and
applying the rising voltage signal having a third peak voltage during a third rising application period if the temperature is above the first temperature range, the third rising application period being shorter than the first rising application period, the third peak voltage being greater than the first peak voltage.

11. The method of claim 10, wherein the step of applying the descending voltage signal includes:
applying the descending voltage signal during a first descending application period if the temperature is in a first temperature range;
applying the descending voltage signal during a second descending application period if the temperature is below the first temperature range, the second descending application period being longer than the first descending application period; and
applying the rising voltage signal at a third descending application period if the temperature is above the first temperature range, the third descending application period being shorter than the first descending application period.
